(19) United States
(12) Patent Application Publication
(10) Pub. No.: US 2018/0319140 A1
(43) Pub. Date: Nov. 8, 2018

(54) ACRYLIC FOR MARINE ENCLOSURE FABRICATION AND ASSOCIATED METHODS

(71) Applicant: Jeffrey Smith, Chester, MD (US)

(72) Inventor: Jeffrey Smith, Chester, MD (US)

(21) Appl. No.: 15/972,825

(22) Filed: May 7, 2018

Related U.S. Application Data
(63) Continuation-in-part of application No. 13/707,567, filed on Dec. 6, 2012, now abandoned.

(51) Int. Cl. B32B 27/30; B32B 7/08; B32B 5/02; B32B 7/12; B32B 27/12; B29C 47/00; B29C 47/88; B65D 81/30

(52) U.S. Cl. CPC B32B 27/308; B32B 7/08; B32B 5/02; B32B 7/12; B32B 27/12; B29K 2033/04; B29C 47/884; B29C 47/0066; B65D 81/30; B32B 2307/412; B29C 2793/009; B29C 47/0019

(57) ABSTRACT

An acrylic material can block up to about 98% of ultraviolet wavelength radiation from passing through. The acrylic material can also be produced to block a substantial amount of infrared energy, resulting in a material that can be used to fabricate an enclosure that can keep occupants cool and safe from harmful ultraviolet radiation. The acrylic can be manufactured from an acrylic mix containing elements of ultraviolet blocking and infrared blocking technology. The acrylic mix can be extruded in various dimensions and thicknesses, depending on application. For marine enclosure applications, the sheets can be formed in 60-inch by 120-inch by 0.080 inch thick sheets.

### CLAIM OF PRIORITY

The present application is a continuation-in-part application of previously filed, now pending application having Ser. No. 13/707,567, filed on Dec. 6, 2012, which claims the benefit of priority of U.S. Provisional Application Ser. No. 61/567,546, filed Dec. 6, 2011, the contents of which are herein incorporated by reference.

### BACKGROUND OF THE INVENTION

### Field of the Invention

The present invention is directed to a novel acrylic sheet, a novel formation process for the acrylic sheet, as well as a novel formation process for marine enclosures.

### DESCRIPTION OF THE RELATED ART

The present invention relates to marine enclosures made of acrylic panels including at least one semi-rigid, transparent, acrylic sheet with a flexible frame surrounding the panel. The present invention also relates to marine enclosure fabrication processes and, more particularly, to an ultraviolet (UV) and infrared (IR) blocking, transparent, acrylic formation process resulting in a suitable form of acrylic for marine enclosure fabrication, including with respect to size and flexibility to form and fit the curves and shapes required by boats and yachts of present day.

Given that boating is an outdoor recreation that is predominantly conducted on hot or sunny days, the amount of ultraviolet and infrared radiation transmitted through an enclosure on a vessel is likely to create uncomfortable conditions for the occupants, such as increased temperature within the enclosure and increased exposure to harmful radiation. Traditional acrylics have been utilized in marine enclosures, but expose occupants to harmful UV-A rays that are a known factor in melanoma, cataracts, macular degeneration, and adversely affect medicines used for many ailments, because such traditional acrylics were not developed for use as a marine enclosure. These UV rays can also damage objects within the interior of the enclosure, including damaging fabrics, chart books, and the like. Traditional acrylics also allow transmission of infrared radiation which can increase the air temperature within the enclosure, making it uncomfortable to stay within the enclosure. At best, traditional acrylics that have heretofore been available for fabrication of marine enclosures only block about 70% of the incident ultraviolet rays and do not block infrared heat energy.

These traditional acrylics which are generally used to fabricate marine enclosures that are of suitable size and thickness tend to be adapted from large sheets of generic acrylic stock, such as is intended to be used in flat, glazing applications or to be heat molded into rigid structures, but are not necessarily intended to create shelters for the occupants of a vessel. Even where some advances have been made in this field, such as is disclosed in U.S. Pat. No. 5,121,703, these materials tend to be overly rigid and do not allow for curved surfaces as are popular on modern boats and yachts. Previous attempts at blocking UV and IR have been attempted with films or laminates, such as those to Friedman in U.S. Pat. No. 6,596,400 and to Numrich U.S. Pat. Pub. 2010/0189983, but these have proven unsuitable for the curves and flexing dictated by the marine environment and the basic shapes of current boats. Such films and laminates, when stretched on outside perimeters and compressed on inside perimeters, tend to peel or delaminate over time. As such, there is a need in the art which addresses these and other problems.

### SUMMARY OF THE INVENTION

In one aspect of the present invention, a transparent, acrylic panel is formed of at least one 60-inch by 120-inch by 0.080-inch thick acrylic sheet. The acrylic panels are particularly suited for forming an enclosure of one or more acrylic sheets. The acrylic sheets may be formed by extruding a mix of acrylic pellets having ultraviolet blocking elements and infrared blocking elements. In a preferred embodiment, the ultraviolet blocking elements are sufficient to block 98% of ultraviolet radiation from passing through the acrylic sheet. In this embodiment, an acrylic sheet with novel characteristics is formed, the result of which is particularly suitable for creating enclosures to shelter occupants of a vessel.

In another aspect of the present invention, a method for making an enclosure comprises extruding acrylic pellets having ultraviolet blocking elements and infrared blocking elements into one or more acrylic sheets; forming the enclosure with at least one of the one or more acrylic sheets; and preventing at least 90% of ultraviolet radiation from passing through the acrylic pellets with the ultraviolet blocking elements molded into the one or more acrylic sheets.

An acrylic panel of the present invention may be formed of one or more acrylic sheets which have been shaped and/or cut to the desired size and shape. The acrylic panel may also include border fabric around one or more free edges to facilitate the attachment of fasteners, such as zippers, buttons, snaps, or welts. An enclosure according to the present invention may be formed of one or more acrylic panels configured and disposed to at least partially shield the occupants of the vessel on which the enclosure is formed.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a schematic representation of an acrylic formation process according to an exemplary embodiment of the present invention;

FIG. 2 is a flow chart describing steps in the formation of acrylic sheets according to an exemplary embodiment of the present invention; and

FIG. 3 is a cross-sectional view of an acrylic sheet formed by the process of the present invention, illustrating the reflection of ultraviolet and infrared energy therefrom.

Like reference numerals refer to like parts throughout the several views of the drawings.

### DETAILED DESCRIPTION OF THE PREFERRED EMBODIMENT

The following description is not to be taken in a limiting sense, but is made merely for the purpose of illustrating the general principles of the invention, since the scope of the invention is best defined by the appended claims.

In one embodiment, the present invention provides a transparent acrylic material that can block up to about 98% of ultraviolet wavelength radiation from passing through and may also block a substantial amount of infrared energy, resulting in a material that can be used to fabricate an enclosure that can keep occupants cool and safe from harmful ultraviolet radiation. The acrylic can be manufactured from an acrylic mix containing elements of ultraviolet blocking and infrared blocking technology. The acrylic mix can be extruded in various dimensions and thicknesses, depending on application. For marine enclosure applications, the sheets can be formed in 60-inch by 120-inch by 0.080 inch thick sheets.

The acrylic of the present invention can produce an enclosure, for example, a marine enclosure, with ultraviolet and infrared blocking technology that can keep occupants nearly 10 degrees cooler than conventional enclosures.

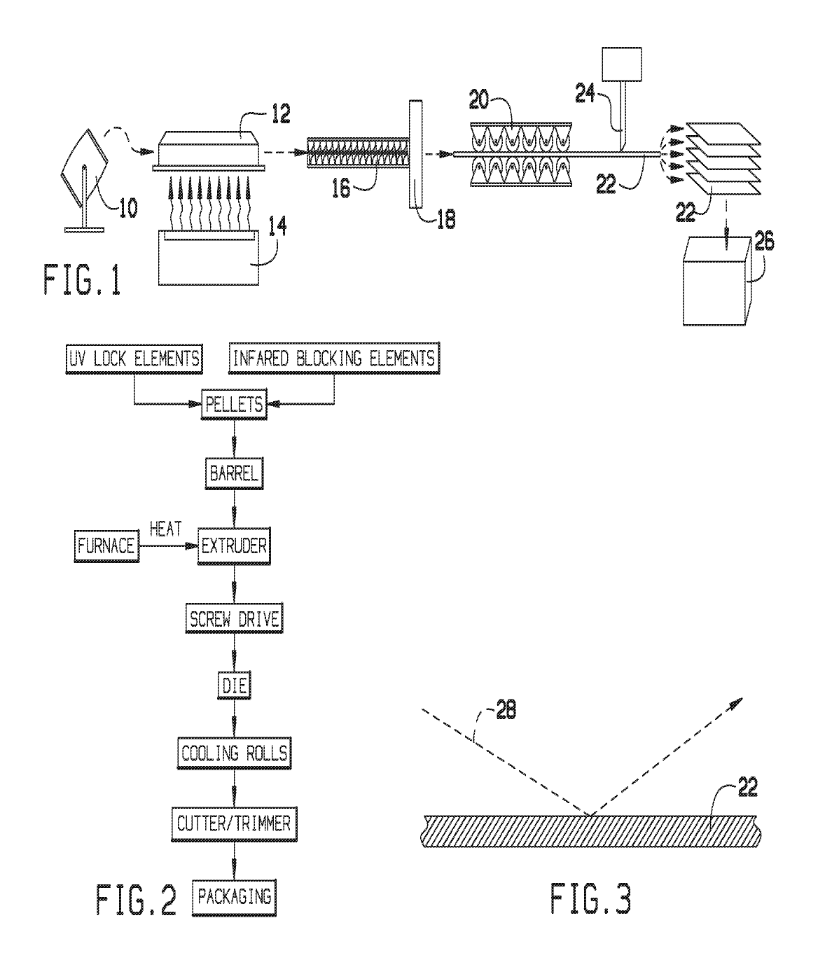

Referring now to FIGS. 1 and 2, an exemplary method for making an acrylic sheet according to one embodiment of the invention, which may be used for enclosures, is shown and described. First, an acrylic mix is formed that includes at least acrylic pellets, ultraviolet blocking elements, and infrared blocking elements. In at least one embodiment, the acrylic mix can be formed as pellets and fed into a barrel 10 of an extruder 12. A furnace 14 can heat the pellets until they are a molten mass. The resulting molten mass is then slowly pushed by a screw drive 16 and forced out through a die 18 as a molten acrylic sheet, the spacing of which determines the thickness of the acrylic sheet. Typically, the sheet thickness is 0.080 inch, but, in some embodiments, a thickness from about 0.049 to about 0.098 inch could be used, for example.

The continuously extruded acrylic sheet may be passed through a set of cooling rollers 20 and can be cut or trimmed to a final size with a cutter 24. Typically, this final size can be a sheet that is 60-inch by 120-inch, although other sizes can be chosen within the scope of the present invention.

The resulting acrylic sheets 22 can be masked on each side and wrapped, typically five acrylic sheets 22 together, in plastic to prevent humidity intrusion. The wrapped acrylic sheets 22 can be wrapped and packaged in a cardboard box 26 as a case product that can be effectively handled and shipped to fabricators.

In some embodiments, the acrylic sheets 20 may be extruded in 10-foot widths and cut down to 5-foot widths, or variations thereof, to produce sheets usable in different applications. As shown in FIG. 3, when impinged upon by ultraviolet and/or infrared radiation 28, this radiation is largely reflected by the sheet 22, rather than passing through the sheet 22. The sheet 22 can block at least 90% of ultraviolet radiation from passing therethrough. In preferred embodiments, the sheet can block about 95% of ultraviolet radiation. In most preferred embodiments, the sheet can block up to about 98% of ultraviolet radiation.

The resulting acrylic sheet 22 can be cut according to shapes dictated by patterns taken from the vessel on which the enclosure is to be disposed. Border fabrics may be bonded to all edges of the acrylic sheet 22, enabling zippers, welt, snaps and other fasteners to be attached to the fabric. The finished enclosure is then able to be installed on the vessel, utilizing the zipper, welt, snaps, or the like. The installed enclosure protects occupants from harmful ultraviolet radiation and comforts them by blocking substantial infrared heat.

The finished acrylic panels can be installed in various applications, such as an awning application that can provide occupants the same protection afforded that of vessels. The same finished acrylic panels may be installed on a variety of vehicles, such as tractors. The acrylic panels may also be utilized in a fence application, providing ultraviolet protection and cool comfort to those in pool settings and the like. The acrylic panels may also also be used to enclose porches and other similar areas, allowing light to brighten the interior while minimizing harmful ultraviolet or temperature raising infrared radiation from passing through. The acrylic panels of the present invention could be useful in applications where persons need sunlight for psychological stability, while needing protection from ultraviolet radiation for physical wellness.

It should be understood, of course, that the foregoing relates to exemplary embodiments of the invention and that modifications may be made without departing from the spirit and scope of the invention as set forth in the following claims.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. A method of forming an acrylic sheet for enclosures comprising:
preparing a mix of acrylic pellets including at least ultraviolet blocking elements and infrared blocking elements;
heating the mix until molten;
extruding the molten mix through a die forming an acrylic sheet;
passing the acrylic sheet through a set of cooling rollers; and
cutting the acrylic sheet to a final size with a cutter.

2. The method as recited in claim 1 wherein the die includes a spacing between 0.049 and 0.098 inches

3. The method as recited in claim 1 wherein the die includes a spacing of 0.080 inches.

4. The method as recited in claim 1 wherein the final size of the acrylic sheet is 60 inches by 120 inches.

5. The method as recited in claim 1 wherein the amount of ultraviolet blocking elements is sufficient to enable the sheet to block at least 98% of ultraviolet wavelength radiation from passing therethrough.

6. The method as recited in claim 5 wherein the sheet is transparent.

7. An acrylic panel for forming an enclosure, comprising:
at least one transparent acrylic sheet;
said at least one transparent acrylic sheet formed by extrusion of molten mix of acrylic pellets, said mix of acrylic pellets including at least ultraviolet blocking elements an infrared blocking elements.

8. The acrylic panel as recited in claim 7 wherein said at least one transparent acrylic sheet comprises a thickness of 0.080 inches

9. The acrylic panel of claim 7, wherein said ultraviolet blocking elements are sufficient to block at least 98% of ultraviolet radiation from passing through said at least one transparent acrylic sheet.

10. The acrylic panel of claim 7 further comprising border fabric bonded to all edges of said at least on transparent acrylic sheet.

11. The acrylic panel of claim 10 further comprising a plurality of fasteners attached to said border fabric.

12. The acrylic panel of claim 7, wherein the enclosure is a marine enclosure.

13. The acrylic panel of claim 7, wherein the one or more acrylic sheets block at least a portion of infrared radiation from passing therethrough.

14. A marine enclosure comprising:
a plurality of acrylic panels;
each of said plurality of acrylic panels comprised of at least one acrylic sheet;
each of said plurality of acrylic sheets including ultraviolet blocking elements and infrared blocking elements.

15. The marine enclosure as recited in claim 14 wherein said plurality of acrylic panels each further comprise border fabric disposed about a plurality of edges of said plurality of acrylic panels.

16. The marine enclosure as recited in claim 15 further comprising a plurality of fasteners disposed on each of said border fabric.

17. The marine enclosure as recited in claim 14 wherein said ultraviolet blocking elements are sufficient to block at least 98% of ultraviolet wavelength radiation from passing through said at least one acrylic sheet.
